(19) United States
(12) Patent Application Publication
(10) Pub. No.: US 2003/0014527 A1
(43) Pub. Date: Jan. 16, 2003

(54) System for registering a recordable medium, system for authenticating a recordable medium, as well as servers and a client system for such systems

(76) Inventors: Johannes Gerardus Hendricus Terwindt, Utrecht (NL); Robert Poulus, Numansdorp (NL); Jan Jaap Twigt, Vleuten (NL)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/097,922

(22) Filed: Mar. 13, 2002

Related U.S. Application Data
(63) Continuation of application No. PCT/NL01/00537, filed on Jul. 12, 2001.

(30) Foreign Application Priority Data
Jul. 13, 2001 (NL) 1015702

(51) Int. Cl. G06F 15/16

(52) U.S. Cl. 709/227; 709/203

(57) ABSTRACT

A system for registering a recordable medium comprises a plurality of client systems and a system server. Each client system can establish a connection to the system server through a network. The system server comprises a client database, in which details of the client systems are registered. Each client system is or can be connected to a medium player, and each client system is adapted for establishing a connection to the system server when a recordable medium is placed in the medium player. The system server generates a unique identification code, which the system server stores in the database along with the client system concerned and delivers to the client system concerned. Each client system is adapted to recording the received unique identification code through the medium player on the recordable medium. Each client system can download content files from a content server for recording on a recordable medium. Upon receipt of a download command from a client system the content server requests the unique identification code of the medium placed in the medium player from the client system. The unique identification code is delivered to the system server, and checked for authenticity by the system server. The content file is only delivered to the client system when the unique identification code is recognized by the system server.

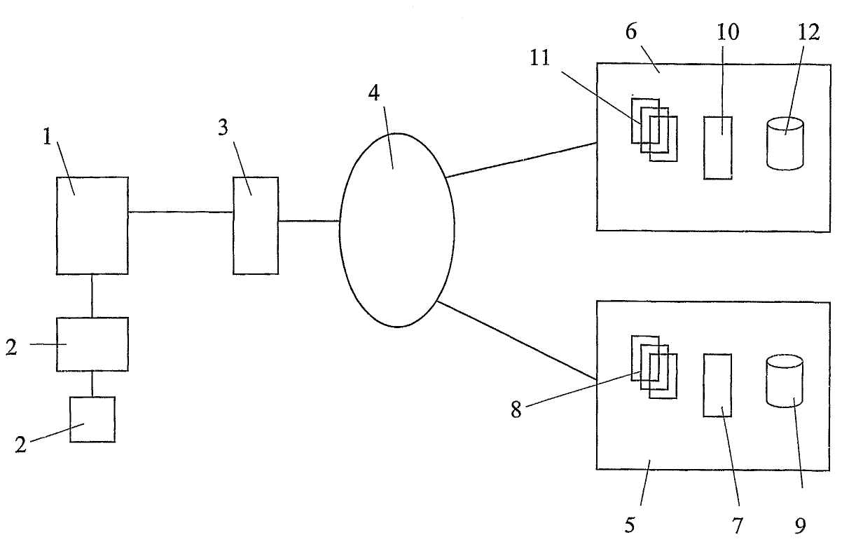

### RELATED APPLICATION

This is a 35 U.S.C. §365(c) continuation of International Application No. PCT/NL01/00537 designating the United States of America, filed Jul. 12, 2001.

The invention relates to a system for registering a recordable medium, to a system for authenticating a recordable medium, as well as to servers and client systems for use in such systems.

Client systems, in particular PCs, are used on a large scale for downloading files from a server. Usually this takes places through the Internet, wherein audio, video or game files are downloaded for recording on a recordable medium, such as a CD-R, CD-RW, recordable DVD or memory card. Although offering and selling such files through the Internet is very attractive for producers of such files, no simple system has to date been available with which this is possible in a reliable way. A substantial part of the files offered through the Internet are to this date offered without the proprietor's permission. There is thus a great need for systems with which legal downloading of files of this type is possible, wherein payment of a fee to the proprietors is ensured.

It is an object of the present invention to provide systems of the above-mentioned type that meets this need.

Accordingly, the system for registering a recordable medium according to the invention is characterised by a plurality of client systems and a system server, wherein each client system is capable of establishing a connection to the system server through a network, wherein the system server comprises a client database, in which details of the client systems are registered, wherein each client system is or can be connected to a medium player, wherein each client system is adapted for establishing a connection to the system server when a recordable medium is placed in the medium player, wherein the system server generates a unique identification code, which the system server stores in the database along with the client system concerned, and provides to the client system concerned, wherein each client system is adapted to storing the unique identification code through the medium player on the recordable medium.

The system for authenticating a recordable medium according to the invention is characterised by a plurality of client systems, a system server and at least one content server, wherein each client system is capable of establishing a connection to the server(s) through a network, wherein the system server comprises a client database, in which details of the client systems, including associated unique identification codes of recordable media, are registered, wherein each client system is or can be connected to a medium player, wherein each client system is capable of downloading content files from a content server for recording on a recordable medium, wherein the content server, upon receipt of a download command from a client system, requests the unique identification code of the recordable medium placed in the medium player from the client system, wherein the unique identification code is delivered to the system server, and checked for authenticity by the system server, wherein the content file is only delivered to the client system when the unique identification code is recognised by the system server.

In this way, systems are provided with which, on the one side, recordable media used for recording content files can be registered with a system server through unique identification codes, which codes can subsequently be used by the system for authenticating a recordable medium that is offered for storing a file to be downloaded. In this way, the system server can record that a certain client system has stored a certain file on a medium. The owed costs can then be charged to the user.

The invention will now be described in further detail with reference to the drawing, which schematically shows the system according to the invention.

It is noted that a client system is understood to mean any system that can be used by a user for downloading files from a multi-media network, such as the Internet. Examples of such systems are a PC, a laptop, a mobile telephone, an MP3-player, a PDA and such like.

The drawing shows very schematically a client system 1, to which a medium player 2 is connected, with which files can be stored on recordable media. Examples of recordable media are CD-RS, CD-RWs, recordable DVDs, memory cards, memory sticks and such like. The client system 1 can establish a connection through a communications network, not shown, to a server 3 of an Internet service provider (ISP), who provides the client system 1 with a connection to the schematically indicated Internet 4. In the system described, a system server 5 and a content server 6 are also connected to the Internet 4. It is noted that a large number of client systems 1 and content servers 6 will usually be connected. If desired, more than one system server 5 can be used. Further, it is possible for the system server 5 to also act as content server 6.

The system server 5 comprises a web server 7, offering a web site having a number of web pages 8 on the Internet. A client database 9 is connected to the web server 7. Correspondingly, the content server 6 comprises a web server 10 offering a web site having a number of web pages 11 on the Internet 4. A content database 12 is connected to the web server 10. It is noted that content is understood to refer to several types of file, such as audio files, video files, game files, computer software files and such like.

The described system operates as follows. Suitable application software providing the described functions is installed on the client system 1, the system server 5 and the content server 6. Under the direction of the software the client system 1 can apply for registration of the client system in the client database 9 to the system server through the Internet 4. On registration as a participant in the system details of the client system/user are stored in the client database. Web pages 8 are used for providing these details in a manner known as such. The details preferably comprise the telephone number or another access number or address, of which the client system 1 avails itself to establish a connection to the ISP server 3. The use of this access number as one of the details to be registered has the advantage that the system server 5 can verify that the access number is correct, as the system server 5 is provided with the access number that the client system 1 is actually using by the telephone company through the ISP server 3. The usual other details will be stored along with the client details, such as name, address, place of residence and, for example, bank account. Usually, the client system 1 will also be issued a log-on code and an identification code for logging in on the system server 5.

If a recordable medium 2′ is placed in the medium player 2, this is detected by the client system 1. The client system 1 will then preferably automatically establish a connection through the Internet 4 to the system server 5, wherein the system server 5 can identify the client system 1 by the access number or address used. The client system 1 reports the medium 2′ placed in the medium player 2 to the system server 5, and the system server generates a unique identification code, which is stored in the client database 9, and provided to the client system 1. The client system 1 writes this unique identification code to the medium 2′. In this way, each user can report the media on which he wants to store content files to the system server 5, whereby a unique identification code is stored on each recordable medium, which is also stored along with the details of the client system concerned in the database 9.

In the system according to the invention, recordable media that have been provided with a production or system code beforehand are preferably used. This system code is recognised by the client system 1, and the client system 1 only establishes a connection to the system server 5, when such a system code is recognised. If desired, it is also possible to use recordable media that are already provided with a system code and unique identification codes at production. In that case, the client system 1 will establish a connection with the system server 5 to provide the unique identification code already present on the medium to the system server for storing in the client database 9.

When a user retrieves web pages 11 from the web site of a content server 6 on which files are indicated that can be downloaded, the user can indicate in a manner known as such, by clicking or such like, that he wants to download a file, for example an audio file. The content server 6 then sends a command to the client system 1 to read the unique identification code of the medium 2′. The client system 1 subsequently sends this unique identification code to the system server 5 for verification of its authenticity. The system server 5 checks in the database 9, whether the unique identification code is present, preferably using the access number or address used by the client system as access to the database 9. If the verification establishes that a registered medium 2′ has been placed in the medium player 2 at a registered client system 1, the client system 1 is authorised to download the requested file and to store it on the medium 2′.

It is noted that it is also possible to have the client system 1 deliver the unique identification code to the content server 6, whereafter verification of authenticity takes place in communication between the content server 6 and the system server 5.

A specific telephone number is preferably supplied by the content server 6 to the client system 1 for use in the external connection, whereafter the client system establishes a connection to the system server through this specific telephone number. This telephone number can, for example, be a toll number or ensure payment for the chosen content in a different manner. This is possible, for example, by including a specific telephone number for each file that can be downloaded from the content server 6, wherein establishing a connection through one of these telephone numbers affords the system server 5 the possibility of charging an associated amount to the client system 1's account.

If users assent to this, the system server S/content server 6 can also be used for recording content preference, so that the users can be provided with targeted information on new content.

The invention is not restricted to the above-described embodiments, which can be varied in a number of ways within the scope of the attached claims.

1. System for registering a recordable medium, characterised by a plurality of client systems and a system server, wherein each client system is capable of establishing a connection to the system server through a network, wherein the system server comprises a client database, in which details of the client systems are registered, wherein each client system is or can be connected to a medium player, wherein each client system is adapted for establishing a connection to the system server when a recordable medium is placed in the medium player, wherein the system server generates a unique identification code, which the system server stores in the database along with the client system concerned, and provides to the client system concerned, wherein each client system is adapted to storing the unique identification code through the medium player on the recordable medium.

2. System according to claim 1, wherein recordable media have been provided with a system code beforehand, which is recognised by a client system when the medium is placed in the medium player, wherein the client system only establishes a connection to the system server for registering and applying a unique identification code when a medium with system code is placed in the medium player.

3. System according to claim 1, wherein the details of the client systems comprise at least an access number or address, which the client system uses for establishing a connection to the system server.

4. System for authenticating a recordable medium, characterised by a plurality of client systems, a system server and at least one content server, wherein each client system is capable of establishing a connection to the server(s) through a network, wherein the system server comprises a client database, in which details of the client systems, including associated unique identification codes of recordable media, are registered, wherein each client system is or can be connected to a medium player, wherein each client system is capable of downloading content files from a content server for recording on a recordable medium, wherein the content server, upon receipt of a download command from a client system, requests the unique identification code of the recordable medium placed in the medium player from the client system, wherein the unique identification code is provided to the system server, and checked for authenticity by the system server, wherein the content file is only delivered to the client system when the unique identification code is recognised by the system server.

5. System according to claim 4, wherein each client system is adapted to establishing a dial-up connection through a certain access number for providing the requested unique identification code to the system server, wherein payment of the requested content file is preferably registered through this certain access number.

6. System according to claim 4, wherein the details of the client systems comprise at least an access number or address, which the client system uses for establishing a connection to the system server, wherein the system server in checking the unique identification code, further checks the access number or address that the client system is using, wherein the content file is only delivered to the client system when both the access number or address and the unique identification code are recognised by the system server.

7. System server for use in a system according to claim 1, comprising a client database for registering details of client systems, the system server being adapted for generating unique identification codes for recordable media, which are stored in the database along with associated client systems, and are delivered to an associated client system.

8. System server according to claim 7, wherein the system server is adapted for checking a unique identification code of a recordable medium, which has been received from a client system.

9. Content server for use in a system according to claim 4, adapted for requesting an identification code of a recordable medium upon receipt of a download command from a client system.

10. Client system for use in a system according to claim 1, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

11. Computer program comprising computer program code, which, when executed on a computer, allows it to function as the client system of claim 10.

12. Computer program according to claim 11, stored on a computer readable medium or in a file downloadable to a computer.

13. System according to claim 2, wherein the details of the client systems comprise at least an access number or address, which the client system uses for establishing a connection to the system server.

14. System according to claim 5, wherein the details of the client systems comprise at least an access number or address, which the client system uses for establishing a connection to the system server, wherein the system server in checking the unique identification code, further checks the access number or address that the client system is using, wherein the content file is only delivered to the client system when both the access number or address and the unique identification code are recognised by the system server.

15. System server for use in a system according to claim 2, comprising a client database for registering details of client systems, the system server being adapted for generating unique identification codes for recordable media, which are stored in the database along with associated client systems, and are delivered to an associated client system.

16. System server for use in a system according to claim 3, comprising a client database for registering details of client systems, the system server being adapted for generating unique identification codes for recordable media, which are stored in the database along with associated client systems, and are delivered to an associated client system.

17. System server for use in a system according to claim 4, comprising a client database for registering details of client systems, the system server being adapted for generating unique identification codes for recordable media, which are stored in the database along with associated client systems, and are delivered to an associated client system.

18. System server for use in a system according to claim 5, comprising a client database for registering details of client systems, the system server being adapted for generating unique identification codes for recordable media, which are stored in the database along with associated client systems, and are delivered to an associated client system.

19. System server for use in a system according to claim 6, comprising a client database for registering details of client systems, the system server being adapted for generating unique identification codes for recordable media, which are stored in the database along with associated client systems, and are delivered to an associated client system.

20. Content server for use in a system according to claim 5, adapted for requesting an identification code of a recordable medium upon receipt of a download command from a client system.

21. Content server for use in a system according to claim 6, adapted for requesting an identification code of a recordable medium upon receipt of a download command from a client system.

22. Client system for use in a system according to claim 2, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

23. Client system for use in a system according to claim 3, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

24. Client system for use in a system according to claim 4, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

25. Client system for use in a system according to claim 5, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

26. Client system for use in a system according to claim 6, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

27. Client system for use in a system according to claim 7, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

28. Client system for use in a system according to claim 8, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.

29. Client system for use in a system according to claim 9, the client system being or being capable of being connected to a medium player, wherein the client system is adapted for establishing a connection to the system server when a recordable medium is placed in the medium player, wherein the client system is adapted for storing a received unique identification code on the recordable medium through the medium player, wherein the client system is adapted for downloading content files from a content server for recording on a recordable medium placed in the medium player, wherein the client system is adapted to provide the unique identification code of the medium placed in the medium player to the system server under instruction from the server.
